(19) United States
(12) Patent Application Publication
(10) Pub. No.: US 2011/0260511 A1
(43) Pub. Date: Oct. 27, 2011

(54) BICYCLE SEAT

(76) Inventor: JEROME SIRJORD, NORTH ULEN, MN (US)

(21) Appl. No.: 13/091,618

(22) Filed: Apr. 21, 2011

Related U.S. Application Data
(60) Provisional application No. 61/326,407, filed on Apr. 21, 2010.

(51) Int. Cl. B62J 1/18; B23P 11/00

(52) U.S. Cl. 297/201; 29/428

(57) ABSTRACT

A bicycling seat configuration and method of use comprising: a horizontally expandable base; a first seat pad, where at least one post extends from the base to support the first seat pad; a second seat pad, where at least one post extends from the base to support the second seat pad, where the first seat pad and second seat pad form are positioned to form an adjustable gap; and a connecting post, said connecting post extends from the base and provides a mechanism to mount the seat configuration on a bicycle. The bicycling seat configuration according to the present invention may also include a swivel mount for each seat pad.

### CROSS REFERENCE TO OTHER APPLICATIONS

This application claims priority to U.S. Provisional Application Ser. No. 61/326,407 filed on Apr. 21, 2010.

### BACKGROUND OF THE INVENTION

1. Field of Invention

The present invention relates to a specific bicycle seat design that includes a dual padded seat with a swivel adjustment feature to provide further comfort for the bike rider.

2. Description of Related Art

A bicycle is a human-powered two-wheel vehicle that is powered by a pedal, chain and gear assembly. The common shape of the bicycle is upright position that includes cross handlebars and a seat for an individual to rest their derriere. Bicycles are used for various purposes: commuting, delivery services, recreation, racing and novelty bicycles such as BMX bikes. One essential component of the bicycle is the bicycle seat or saddle that varies in design based upon the use of bicycle, type of bicycle, and the type of riding. The type of seat used is very dependent upon the position of the rider in most instances. When using a comfort or hybrid type of bicycle a cyclist will sit higher over the seat where their weight is directed downward on the saddle, consequently a wider and more cushioned saddle is more suitable for such use. Racing or road bicycles use narrow and harder seats to provide less friction and interference with the fast pedal movements associated with racing. Also racers tend to bend over, therefore weight is more evenly distributed between the handlebars and the saddle as opposed to the hybrid or comfort style of bicycle.

Many bicycle seats fall into specific broad categories, which include the race or road style seat that tends to be a narrow lightweight seat with a stiffer top. Mountain style seats are fairly narrow in shape with additional padding to soften blows and to adjust for some of the off-road conditions of mountain biking. Some bicycle seats include gel type cushioning to absorb shocks and to mold to the shape of the rider's body. Other bicycle seats have suspension that supplies support on the underside of the seat and other seats include cutaway sections where material is removed to eliminate some of the pressure points along the seat. As noted above, the more comfort or hybrid type of riding bicycles include wide cushioned seats that supply lots of padding and may include some ring support for the underside. These seats are very conducive for cyclists who are not pedaling very fast or riding aggressively. Consequently various seat designs exist in the prior art. However additional designs are conceivable and needed to provide even more comfortable seat configurations for bicycle riding.

### SUMMARY OF THE INVENTION

The present invention relates to a bicycling seat configuration comprising: a horizontally expandable base; a first seat pad, where at least one post extends from the base to support the first seat pad; a second seat pad, where at least one post extends from the base to support the second seat pad, where the first seat pad and second seat pad form are positioned to form an adjustable gap ; and a connecting post, said connecting post extends from the base and provides a means to mount the seat configuration on a bicycle. The bicycling seat configuration according to the present invention may also include a swivel mount for each seat pad.

The present invention may also relate to a method of providing an adjustable bicycle seat comprising the steps of: providing a horizontally adjustable base; mounting a first seat pad on the base; mounting a second seat pad on the base; positioning the first seat pad and second seat pad to create a gap between the first seat pad and second seat pad; and extending a connecting post from the base; and inserting the connecting post onto a bicycle.

### BRIEF DESCRIPTION OF DRAWINGS

FIG. 1 depicts a prospective view of a bicycle seat according to the present invention.

FIG. 2 provides a side view of a bicycle seat according to the present invention.

### DETAILED DESCRIPTION

The present invention relates to a bicycle seat design that includes dual seating pads that swivel about a base in order to provide a comfortable seat for use on a bicycle. The bicycle seat according to the present invention is especially useful for individuals who may have suffered injuries or have limitations to their lower extremities near the pelvic area and find the use of a conventional bicycle seat uncomfortable or unbearable over a period of time. The seat design according to the present invention is a split seat that has dual pads where one pad is provided for each side of an individual's derriere. Also each individual pad of the split seat pivots across a base portion to provide further comfort while operating a bicycle. In addition the width of the space between the split seat pads is adjustable so that the seat may adjust to the needs of each individual rider.

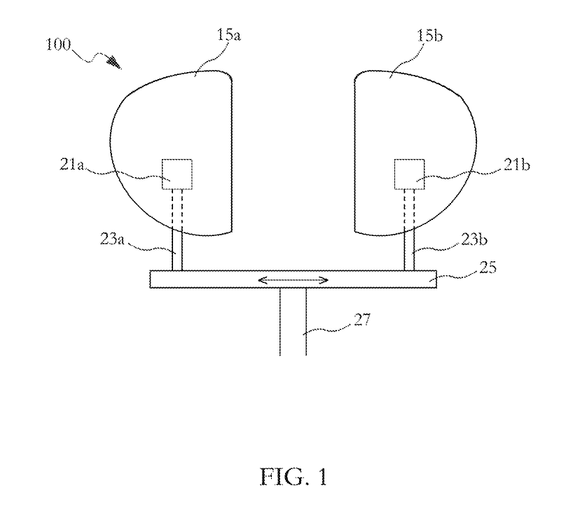

FIG. 1 depicts a prospective view of a seat design 100 according to the present invention. The seat design 100 includes two seat pads, a first seat pad 15a, and the second seat pad 15b. The seat pads 15a, 15b are mounted on swivel mounts 21a, 21b respectively. The swivel mounts 21a, 21b are attached to posts 23a, 23b. This assembly of the seat design 100 provides a separate pad for each side of the seat and consequently a seat pad for each side of a rider's derriere. The base 25 of the seat design 100 expands and contracts horizontally in order to change the width or spacing between the seat pads 15a, 15b. This expansion and contraction feature of the base 25 enables the seat to be adjustable width wise to conform to different sizes of riders. Further expansion and contraction allows the user to provide a suitable width that's most comfortable for the rider's specific needs. A connecting post 27 is provided under the base 25 that connects the seat design 100 onto a conventional bicycle.

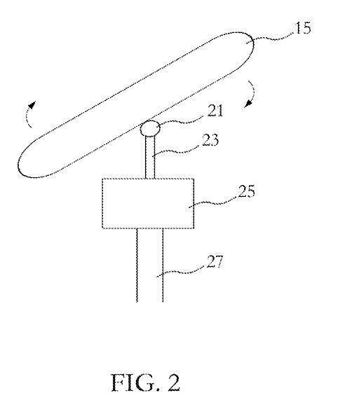

FIG. 2 depicts a side view of the seat design 100 according to the present invention. One seat pad 15 is depicted upon a swivel mount 21. The seat pad 15 rotates as needed or swivels about the swivel mount 21 as shown in the directional arrows provided in FIG. 2. The remaining portions of the seat assembly 100 are also depicted including the post 23 on top of the base 25. The movement of this seat pad 15 provides a more comfortable positioning of a bicycle seat and moves in accordance with the movements of the rider and therefore remains in comfortable contact with the rider's derriere.

The use of this seat design 100 according to the present invention is to provide a user with a comfortable seat that eliminates excessive pressure in the genitals and pelvic areas of the rider. The seat design 100 provides an ergonomic design with the pivoting feature where the seat pads pivot in accordance with the movements of the rider's body. The comfort provided by the seat design 100 helps to limit chafing and excessive friction that may be encountered with use of a conventional seat. Further with the open midsection and pad for each individual side of the rider's derriere the pressure point at the pelvic area is eliminated. The instant invention has been shown and described in what it considers to be the most practical and preferred embodiments. It is recognized, however, that departures may be made there from within the scope of the invention and that obvious modifications will occur to a person skilled in the art.

What is claimed is:

1. A bicycling seat configuration comprising:
a. a horizontally expandable base;
b. a first seat pad, where at least one post extends from the base to support the first seat pad;
c. a second seat pad, where at least one post extends from the base to support the second seat pad, where the first seat pad and second seat pad form are positioned to form an adjustable gap ; and
d. a connecting post, said connecting post extends from the base and provides a means to mount the seat configuration on a bicycle.

2. The bicycling seat configuration according to claim 1, where a swivel mount is provided for each seat pad.

3. A method of providing an adjustable bicycle seat comprising the steps of:
a. providing a horizontally adjustable base;
b. mounting a first seat pad on the base;
c. mounting a second seat pad on the base;
d. positioning the first seat pad and second seat pad to create a gap between the first seat pad and second seat pad; and
e. extending a connecting post from the base; and
f. inserting the connecting post onto a bicycle.

4. The method of providing an adjustable bicycle seat according to claim 3, further comprising the steps of:
a. providing a post for the first seat pad and a post for the second seat pad, where each post connects each respective seat pad to the base.

5. The method of providing an adjustable bicycle seat according to claim 3, further comprising the steps of
a. providing a swivel mount for the first seat pad; and
b. providing a swivel mount for the second seat pad.
